(19) United States
(12) Patent Application Publication
(10) Pub. No.: US 2022/0270564 A1
(43) Pub. Date: Aug. 25, 2022

(54) DISPLAY SYSTEM AND VIDEO DATA DISPLAYING METHOD THEREOF

(71) Applicant: FORCELEAD TECHNOLOGY CORP., Jhubei City (TW)

(72) Inventors: CHAO-CHYUN CHEN, Jhubei City (TW); YUNG-SHENG TSENG, Jhubei City (TW); SHAN-HSIAO WU, Jhubei City (TW); CHI-YANG HO, Jhubei City (TW); YUNG-NENG HUNG, Jhubei City (TW)

(21) Appl. No.: 17/667,765

(22) Filed: Feb. 9, 2022

Related U.S. Application Data
(62) Division of application No. 15/833,146, filed on Dec. 6, 2017, now abandoned.
(60) Provisional application No. 62/430,573, filed on Dec. 6, 2016.

(51) Int. Cl. G09G 3/36; G09G 3/20

(52) U.S. Cl. CPC G09G 3/3696; G09G 3/3674; G09G 3/3685; G09G 3/20; G09G 2340/125; G09G 2380/10; G09G 2340/10; G09G 2310/08; G09G 2320/10; G09G 2310/027; G09G 2320/0247; G09G 2330/12; G09G 2320/0285

(57) ABSTRACT

A display system is provided, which may include a processor, a controller, a video combiner and a display panel. The controller receives a first input signal and a second input signal, generates a first control instruction and a second control instruction according to the first input signal and the second input signal respectively, and generates a first video data, a second video data, and a plurality of timing signals respectively according to the first control instruction and the second control instruction. The video combiner combines the first video data with the second video data to generate a combined video data. The display panel displays the combined video data according to the timing signals.

### CROSS REFERENCE TO RELATED APPLICATION

This application is a divisional application of co-pending U.S. application Ser. No. 15/833,146, filed on Dec. 6, 2017, which claims the priority to U.S. provisional Application 62/430,573 filed on Dec. 6, 2016, which is herein incorporated by reference in its entirety.

### TECHNICAL FIELD

The technical field relates to a display system, in particular to a display system capable of displaying multiple sets of video data, and confirming whether the video data displayed are correct. The technical field further relates to the video data displaying method of the display system.

### BACKGROUND

When multiple sets of video data are inputted into a display system with only one display panel, the video data displayed on the display panel may be overlapped with one another. Therefore, the display system cannot correctly display multiple sets of video data.

Currently, there are a lot of video data displaying technologies developed so as to solve the problem that display systems cannot correctly display multiple sets of video data. For example, U.S. Pat. No. 4,215,343 discloses a digital pattern display system; U.S. Pat. No. 4,246,578 discloses a pattern generation display system. However, the above displaying technologies can be only applied to CRT (cathode ray tube) display systems, but cannot be applied to LCD display systems.

Besides, U.S. Pat. No. 4,318,097 discloses a display apparatus for displaying a pattern having a slant portion, which constitutes the displayed video data by rectangular picture elements. U.S. Pat. No. 4,689,316 discloses a character and pattern display system, which stores red, green, and blue background data by 4 display memories so as to generate the colors to be displayed. U.S. Pat. No. 4,827,255 discloses a display control system which produces varying patterns to reduce flickering, which uses the color code information of single frame to display the gray-scale information of multiple frames on a monochrome display screen, and provides a counter for storing the frame number of the gray-scale information. U.S. Pat. No. 4,809,779 discloses a display pattern processing apparatus, which displays the colors of the video data to be displayed by another method. U.S. Pat. No. 6,084,566 discloses a pattern display circuit, which can generate the patterns of video data, and the circuit includes two memories for storing the spaces and positions of the patterns on the display panel. However, the above video data displaying technologies still cannot effectively solve the problem that display systems cannot correctly display multiple sets of video data.

Further, when a video data is inputted into a display system, the display panel of the display system may not correctly display the video data due to data error because the internal circuit of the display system malfunctions, or the format of the inputted video data is incorrect. However, the display system usually cannot determine whether the inputted video data are correctly displayed.

Currently, there are a lot of video data displaying technologies are developed so as to solve the problem that display systems cannot determine whether inputted video data are correctly displayed. For example, U.S. Pat. No. 7,203,359 discloses a split screen technique, which can check whether the difference between the video data currently received and the video data previously received to divide the currently received image into several areas accordingly, and then compare the video data of each of the areas with the video data of each of the areas previously divided. U.S. Pat. No. 8,120,621 discloses a method and system of measuring quantitative changes in display frame content, which can check whether the difference between the video data currently received and the video data previously received to divide the currently received image into several areas accordingly, calculate the cyclic redundancy check (CRC) result of each of the areas, and then compare the cyclic redundancy check result of each of the areas with the cyclic redundancy check result of each of the areas previously divided. However, if the original video data already have errors, the above technologies cannot confirm whether these video data are correct when receiving these video data.

Therefore, it has become an important issue to provide a display system and a video data displaying method thereof in order to solve the shortcomings of the conventional display systems.

### SUMMARY

Therefore, it is a primary objective of the present disclosure to provide a display system and the video data displaying method thereof in order to solve the shortcomings of the conventional display systems.

To achieve the foregoing objective, the present disclosure provides a display system is provided, which may include a processor, a controller, a content checker, and a display panel. The controller may receive an input signal from the processor, and may generate a video data and a plurality of timing signals according to the input signal. The content checker may include a first look-up table; the content checker may compare the video data with the first look-up table, and transmit a report to the controller or the processor according to a comparison result. The display panel displays the video data according to the timing signals.

In an embodiment of the present disclosure, the display system may further include a gate driver circuit and a source driver circuit coupled to the display panel. The timing signals may include a gate timing signal and a source timing signal. The gate driver circuit and the source driver circuit may receive the gate timing signal, the source timing signal, and the video data respectively in order to control the display panel to display the video data.

In an embodiment of the present disclosure, the controller may include a data formatter and a timing controller coupled to the data formatter. The data formatter may convert the input signal into the video data, and the timing controller may generate the timing signals according to the input signal.

In an embodiment of the present disclosure, the data formatter may include a decoder and a data generator coupled to the data generator. The decoder may receive the input signal, and the data generator may output the video data.

In an embodiment of the present disclosure, the decoder may decode the input signal to generate an input video data and a control instruction. The data generator may adjust the input video data according to the control instruction in order to generate the video data.

In an embodiment of the present disclosure, the data generator may further include a second look-up table. The decoder may decode the input signal to generate a control instruction, and the data generator may pick out the corresponding video data from the second look-up table according to the control instruction in order to generate the video data.

In an embodiment of the present disclosure, the content checker may further include a converter and a pattern matching unit. The converter may execute a cyclic redundancy (CRC) check to calculate a cyclic redundancy check result of the video data. The first look-up table may select a pre-calculated cyclic redundancy check result corresponding to the video data from the first look-up table, and output the pre-calculated cyclic redundancy check result to the pattern matching unit. The pattern matching unit compares the cyclic redundancy check result with the pre-calculated cyclic redundancy check result in order to generate the report.

To achieve the foregoing objective, the present disclosure further provides a video data displaying method, which may include the following steps: receiving an input signal, and generating a video data and a plurality of timing signals respectively according to the input signal; comparing the video data with a first look-up table, and generating a report according to a comparison result; and displaying the video data according to the timing signals by a display panel.

In an embodiment of the present disclosure, the method may further include the following steps: executing a cyclic redundancy check to calculate the cyclic redundancy check result of the video data; selecting a pre-calculated cyclic redundancy check result corresponding to the video data from the first look-up table according to the input signal;

and comparing the cyclic redundancy check result with the pre-calculated cyclic redundancy check result in order to generate the report.

In an embodiment of the present disclosure, the method may further include the following step: decoding the input signal to generate an input video data and a control instruction, and adjusting the input video data according to the control instruction in order to generate the video data.

In an embodiment of the present disclosure, the method may further include the following step: decoding the input signal to generate a control instruction, and picking out the corresponding video data from a second look-up table according to the control instruction in order to generate the video data.

To achieve the foregoing objective, the present disclosure still further provides a display system, which may include a processor, a controller, a video combiner and a display panel. The controller can receive a first input signal and a second input signal from the processor, and can generate a first video data, a second video data and a plurality of timing signals according to the first input signal and the second input signal. The video combiner can combine the first video data and the second video data to generate a combined video data. The display panel can display the combined video data according to the timing signals.

To achieve the foregoing objective, the present disclosure still further provides a video data displaying method, which may include the following steps: receiving a first input signal and a second input signal, and generating a first video data, a second video data, and a plurality of timing signals respectively according to the first input signal and the second input signal; combining the first video data with the second video data to generate a combined video data; and displaying the combined video data according to the timing signals by a display panel.

The display system and the video data displaying method thereof according to the present disclosure may have the following advantages:

(1) In one embodiment of the present disclosure, the display system includes a video combiner, which can combine multiple sets of video data to generate a combined video data in order to display the combined video data on a display panel. Thus, the display system can avoid that these video data displayed on the display screen of the display panel are overlapped with one another, so can correctly display multiple sets of video data.

(2) In one embodiment of the present disclosure, the display system includes a video combiner, which can combine multiple sets of video data to generate a combined video data, and can further modify the content of the combined video data. Therefore, the display system can display the combined video data by different ways, which can better the display performance of the display system.

(3) In one embodiment of the present disclosure, the controller of the display system includes a data formatter, which can interpolate or extrapolate additional pixels into the inputted video data. Therefore, the video data can have proper resolution, and can be correctly displayed on a display panel by different ways, which can further better the display performance of the display system.

(4) In one embodiment of the present disclosure, the display system includes a content checker having a look-up table storing correct video data in advance. The content checker can compare an inputted video data with the look-up table in order to determine whether the video data is correct. Accordingly, the display system can effectively confirm whether the inputted video data is correctly displayed on a display panel.

(5) In one embodiment of the present disclosure, the display system and the video data displaying method can be applied to LCD display systems, so are more comprehensive in use.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram of a display system of a first embodiment in accordance with the present disclosure.

FIG. 2 is a schematic diagram of a controller of the first embodiment in accordance with the present disclosure.

FIG. 3 is a first schematic diagram of a data formatter of the first embodiment in accordance with the present disclosure.

FIG. 4 is a flow chart of a video data displaying method of the first embodiment in accordance with the present disclosure.

FIG. 5 is a schematic diagram of a display system of a second embodiment in accordance with the present disclosure.

FIG. 6A˜FIG. 7 is first˜third schematic diagrams of a data formatter of a controller of the second embodiment in accordance with the present disclosure.

FIG. 8 is a flow chart of a video data displaying method of the second embodiment in accordance with the present disclosure.

FIG. 9 is a schematic diagram of a display system of a third embodiment in accordance with the present disclosure.

FIG. 10 is a schematic diagram of a controller of the third embodiment in accordance with the present disclosure.

FIG. 11A and FIG. 11B are first˜second schematic diagrams of a data formatter of the controller of the third embodiment in accordance with the present disclosure.

FIG. 12A and FIG. 12B are first˜second schematic diagrams of a video combiner of the third embodiment in accordance with the present disclosure.

FIG. 13A, FIG. 13B and FIG. 13C are first˜third schematic diagrams of a content checker of the third embodiment in accordance with the present disclosure.

FIG. 14 is a flow chart of a video data displaying method of the third embodiment in accordance with the present disclosure.

FIG. 15 is a schematic diagram of a display system of a fourth embodiment in accordance with the present disclosure.

FIG. 16 is a schematic diagram of a display system of a fifth embodiment in accordance with the present disclosure.

FIG. 17 is a schematic diagram of a display system of a sixth embodiment in accordance with the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

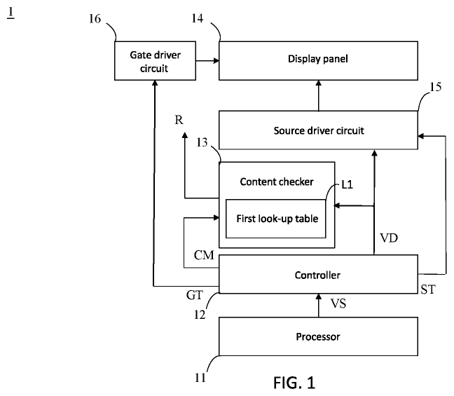

FIG. 1 is a schematic diagram of a display system of a first embodiment in accordance with the present disclosure. As shown in FIG. 1, the display system 1 includes a processor 11, a controller 12, a content checker 13, a display panel 14, a source driver circuit 15, and a gate driver circuit 16.

The processor 11 transmits an input signal VS. In a preferred embodiment, the processor 11 may be a microcontroller, a video processor, etc.

The controller 12 receives the input signal VS from the processor 11, and generates a video data VD, a source timing signal ST, a gate timing signal GT, and a content checking instruction CM according to the input signal VS.

The content checker 13 includes a first look-up table L1. The content checker 13 compares the video data VD with the first look-up table T1 according to the content checking instruction CM. If the video data VD matches the corresponding video data in the first look-up table L1, the content checker 13 transmits a confirmation report R to the controller 12 or the processor 11.

The source driver circuit 15 and the gate driver circuit 16 drive the display panel 14 according to the video data VD, the source timing signal ST, and the gate timing signal GT in order to display the video data VD.

On the contrary, if the video data VD does not match the corresponding video data in the first look-up table L1, the content checker 13 transmits an error report to the controller 12 or the processor 11. Meanwhile, the source driver circuit 15 and the gate driver circuit 16 can still drive the display panel 14 according to the video data VD, the source timing signal ST, and the gate timing signal GT in order to display the video data VD.

Accordingly, the display system 1 can determine whether the inputted video data is correct, so the display system 1 can accurately confirm whether the inputted video data is properly displayed on the display panel 14.

The embodiment described above is just for illustration; the functions of the elements of the display system 1 and the cooperation thereof can be changed according to actual requirements.

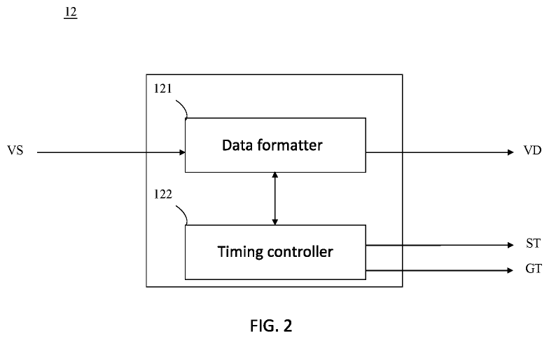

FIG. 2 is a schematic diagram of the controller of the first embodiment in accordance with the present disclosure. As shown in FIG. 2, the controller 12 includes a data formatter 121 and a timing controller 122.

The data formatter 121 converts the input signal VS into the video data VD.

The timing controller 122 respectively generates the source timing signal ST and the gate timing signal GT according to the video data VD.

Besides, the number of the data formatter 121 may be corresponding to the number of the input signals VS in order to deal with the input signals VS respectively.

The embodiment described above is just for illustration; the functions of the elements of the controller 12 and the cooperation thereof can be changed according to actual requirements.

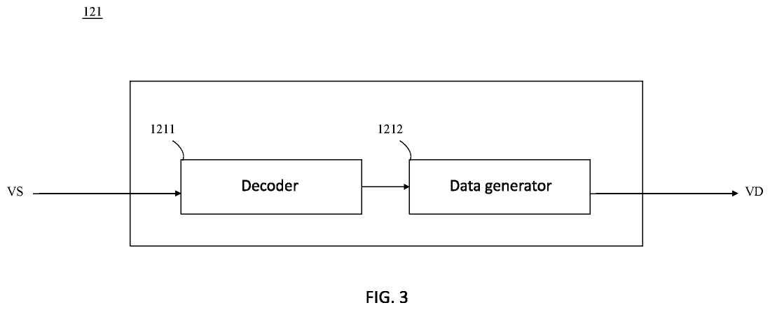

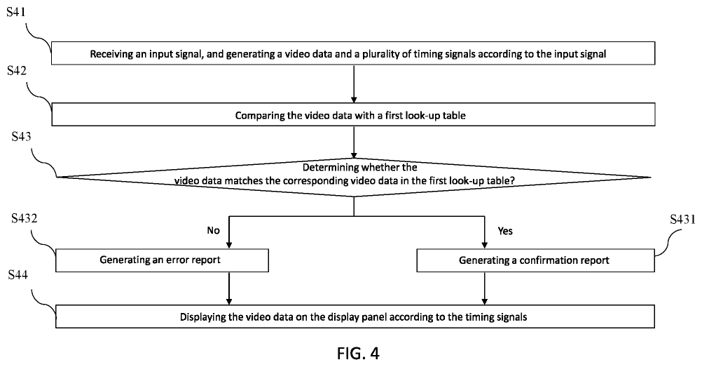

FIG. 3 is a first schematic diagram of the data formatter of the first embodiment in accordance with the present disclosure. As shown in FIG. 3, the data formatter 121 includes a decoder 1211 and a data generator 1212.

The decoder 1211 decodes the input signal VS to generate the video data VD.

The data generator 1212 directly outputs the video data VD.

The embodiment described above is just for illustration; the functions of the elements of the data formatter 121 and the cooperation thereof can be changed according to actual requirements.

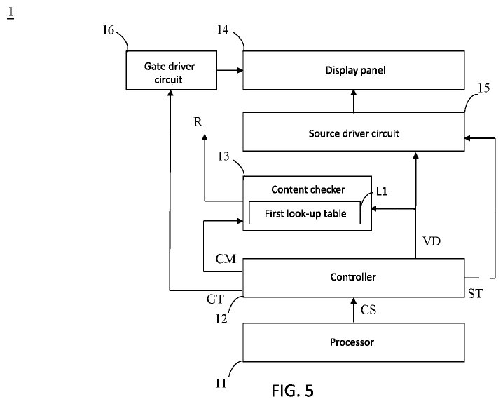

FIG. 4 is a flow chart of a video data displaying method of the first embodiment in accordance with the present disclosure. As shown in FIG. 4, the video data displaying method of the display system 1 includes the following steps:

Step S41: Receiving an input signal, and generating a video data and a plurality of timing signals according to the input signal; then, the process proceeds to Step S42.

Step S42: Comparing the video data with a first look-up table; then, the process proceeds to Step S43.

Step S43: Determining whether the video data matches the corresponding video data in the first look-up table? If it does, the process proceeds to Step S431; if it does not, the process proceeds to Step S432.

Step S431: Generating a confirmation report; then, the process proceeds to Step S44.

Step S432: Generating an error report; then, the process proceeds to Step S44.

Step S44: Displaying the video data on the display panel according to the timing signals.

FIG. 5 is a schematic diagram of a display system of a second embodiment in accordance with the present disclosure. As shown in FIG. 5, the display system 1 includes a processor 11, a controller 12, a content checker 13, a display panel 14, a source driver circuit 15, and a gate driver circuit 16. Similarly, the controller 12 includes a data formatter 121 and a timing controller 122, as shown in FIG. 2.

The processor 11 transmits an input signal CS.

The controller 12 receives the input signal CS from the processor 11, and generates an input signal VD, a source timing signal ST, a gate timing signal GT, and a content checking instruction CM.

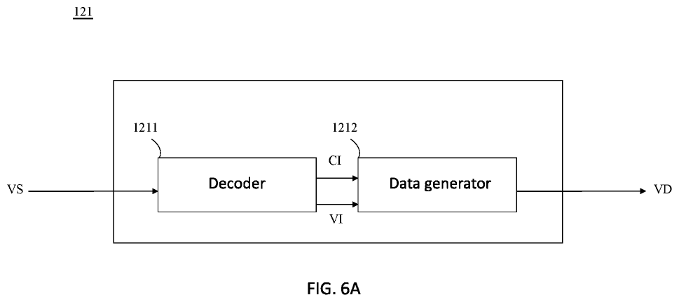

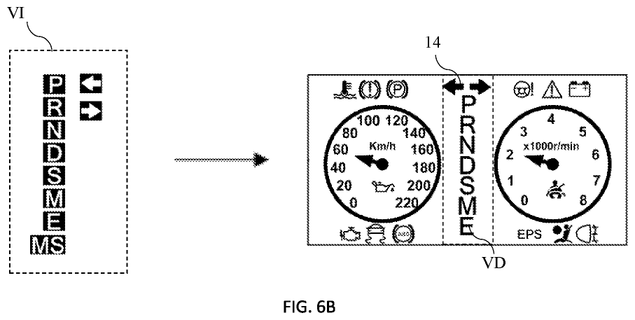

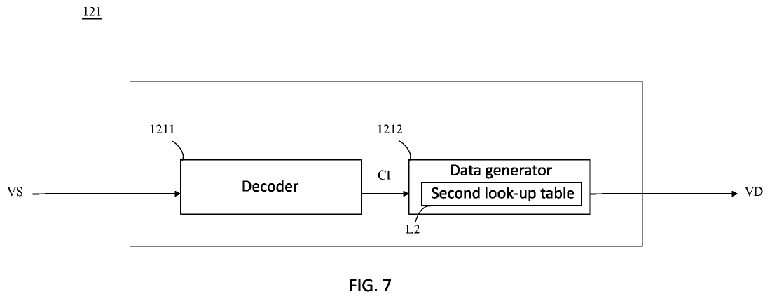

FIG. 6A and FIG. 6B are first˜second schematic diagrams of the data formatter of the controller of the second embodiment in accordance with the present disclosure. As shown in FIG. 6A, the data formatter 121 includes a decoder 1211 and a data generator 1212.

The difference between the embodiment and the previous embodiment is that the input signal CS inputted by the processor 11 includes not only the pattern data to be displayed, but also includes a control instruction CI; besides, the decoder 1211 decodes the input signal CS to generate an input video data VI and the control instruction CI.

The data generator 1212 adjusts the input video data VI according to the control instruction CI in order to generate the video data VD.

As shown in FIG. 6B, the data generator 1212 modifies the video input signal VI according to the control instruction CI (e.g. the data generator 1212 can change the font, arrangement, size, or color of the input video data VI) so as to generate the video data VD, and the displays the video data VD on the display panel 14.

FIG. 7 is a third schematic diagram of data formatter of the controller of the second embodiment in accordance with the present disclosure. FIG. 7 illustrates another kind of data formatter 12. As shown in FIG. 7, the data formatter 121 includes a decoder 1211 and a data generator 1212, and the data generator 1212 includes a second look-up table L2.

The difference between the embodiment and the previous embodiment is that the input signal CS inputted by the processor 11 includes only a control instruction CI, and the decoder 1211 decodes the input signal CS to generate the control instruction CI.

The data generator 1212 picks out the corresponding input video data from the second look-up table L2 according to the control instruction CI in order to generate the video data VD.

More specifically, the data generator 1212 picks out the corresponding input video data from the second look-up table L2 according to the control instruction CI, and then further interpolate or extrapolate additional pixels into the video data VD, or change the video data VD (e.g. the data generator 1212 can change the video data VD from monochrome to colorful according to the control instruction CI). In this way, the data generator 1212 can modify the video data VD to have proper resolution, and can display the video data VD on the display panel 14 by different ways according to different requirements.

The embodiment described above is just for illustration; the functions of the elements of the controller 12 and the cooperation thereof can be changed according to actual requirements.

As described above, if the input signal CS inputted by the processor 11 does not include the control instruction CI, the data formatter 121 can directly decode the input signal CS to generate the video data VD, and directly output the video data VD. On the contrary, if the input signal CS inputted by the processor 11 includes the control instruction CI, the data formatter 121 can modify or generate the video data VD according to the control instruction CI, such that the video data VD can conform to the actual requirements.

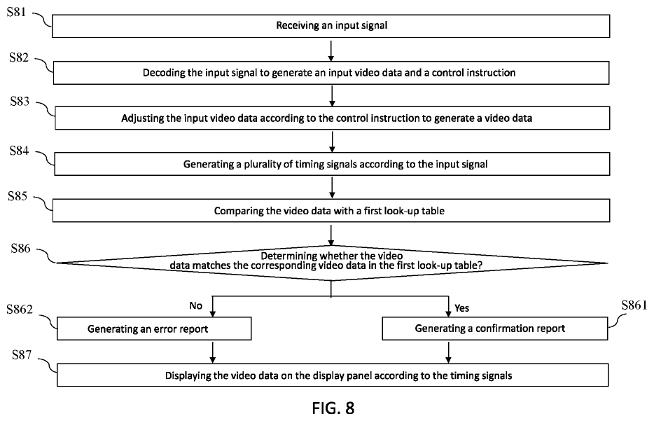

FIG. 8 is a flow chart of a video data displaying method of the second embodiment in accordance with the present disclosure. As shown in FIG. 4, the video data displaying method of the display system 1 includes the following steps:

Step S81: Receiving an input signal; then, the process proceeds to Step S82.

Step S82: Decoding the input signal to generate an input video data and a control instruction; then, the process proceeds to Step S83.

Step S83: Adjusting the input video data according to the control instruction to generate a video data; then, the process proceeds to Step S84.

Step S84: Generating a plurality of timing signals according to the input signal; then, the process proceeds to Step S85.

Step S85: Comparing the video data with a first look-up table; then, the process proceeds to Step S86.

Step S86: Determining whether the video data matches the corresponding video data in the first look-up table? If it does, the process proceeds to Step S861; if it does not, the process proceeds to Step S862.

Step S861: Generating a confirmation report; then, the process proceeds to Step S87.

Step S862: Generating an error report; then, the process proceeds to Step S87.

Step S87: Displaying the video data on the display panel according to the timing signals.

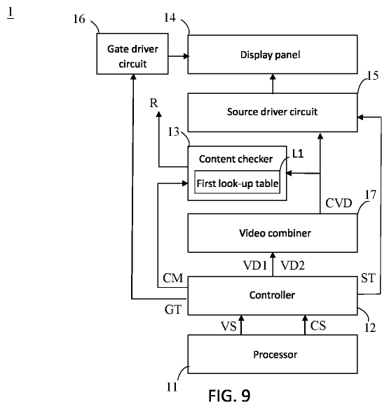

FIG. 9 is a schematic diagram of a display system of a third embodiment in accordance with the present disclosure. As shown in FIG. 9, the display system 1 includes a processor 11, a controller 12, a content checker 13, a display panel 14, a source driver circuit 15, a gate driver circuit 16, and a video combiner 17.

The processor 11 transmits a first input signal VS and a second input signal CS.

The controller 12 receives the first input signal VS and the second input signal CS from the processor 11, and generates a first video data VD1 and a second video data VD2, a source timing signal ST, a gate timing signal GT, and a content checking instruction CM according to the first input signal VS and the second input signal CS.

The video combiner 17 combines the first video data VD1 with the second video data VD2 to generate a combined video data CVD.

The content checker 13 includes a first look-up table L1. The content checker 13 compares the combined video data CVD with the first look-up table T1 according to the content checking instruction CM. If the combined video data CVD matches the corresponding video data in the first look-up table L1, the content checker 13 transmits a confirmation report R to the processor 11. On the contrary, if the combined video data CVD does not match the corresponding video data in the first look-up table L1, the content checker 13 transmits an error report R to the processor 11. Besides, if the first look-up table L1 has no the video data corresponding to the combined video data CVD, the controller 12 displays the combined video data CVD according to a default display mode (e.g. the controller 12 directly displays the combined video data without adjusting the combined video data CVD).

The source driver circuit 15 and the gate driver circuit 16 drive the display panel 14 according to the combined video data CVD, the source timing signal ST, and the gate timing signal GT in order to display the video data VD.

On the contrary, if the video data VD does not match the corresponding video data in the first look-up table L1, the content checker 13 transmits an error report to the controller 12 or the processor 11. Meanwhile, the source driver circuit 15 and the gate driver circuit 16 can still drive the display panel 14 according to the video data VD, the source timing signal ST, and the gate timing signal GT in order to display the video data VD.

Accordingly, the display system 1 can determine whether the inputted video data is correct, so can accurately confirm whether the inputted video data is properly displayed on the display panel 14. In addition, the display system 1 can further combine multiple sets of video data to generate the combined video data CVD, and can display the combined video data CVD by different ways, which can better the display performance of the display system 1.

The embodiment described above is just for illustration; the functions of the elements of the display system 1 and the cooperation thereof can be changed according to actual requirements.

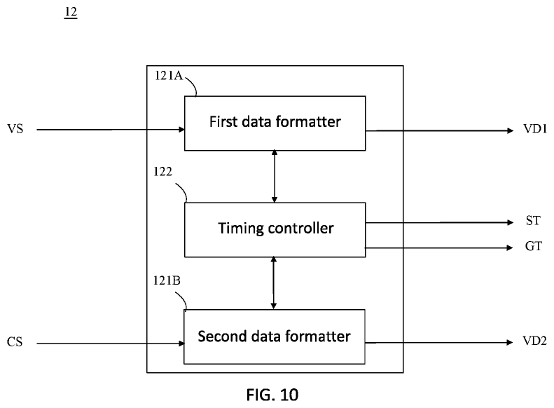

FIG. 10 is a schematic diagram of the controller of the third embodiment in accordance with the present disclosure. As shown in FIG. 3, the controller 12 includes a first data formatter 121A, a second data formatter 121B and a timing controller 122.

The first data formatter 121A converts the first input signal VS into the first video data VD1.

The second data formatter 121B converts the second input signal CS into the second video data VD2.

The timing controller 122 respectively generates the source timing signal ST and the gate timing signal GT according to the first video data VD1 and the second video data VD2.

Besides, the number of the data formatter 121A and 121B may be corresponding to the number of the input signals VS and CS in order to deal with the input signals VS and CS respectively.

The embodiment described above is just for illustration; the functions of the elements of the controller 12 and the cooperation thereof can be changed according to actual requirements.

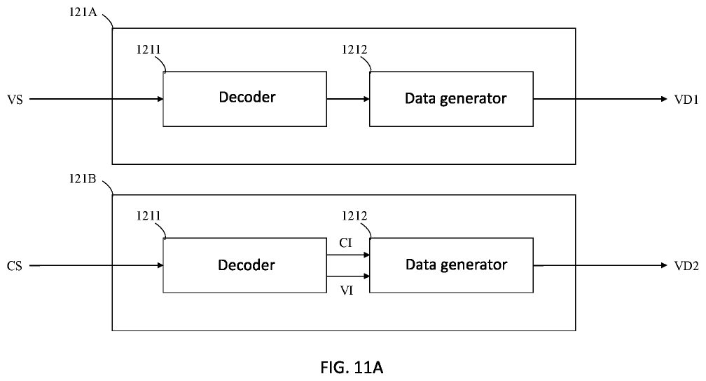

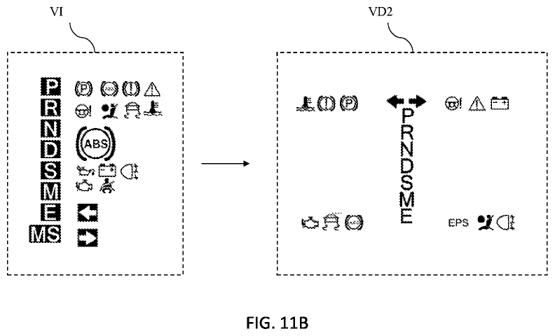

FIG. 11A and FIG. 11B are first˜second schematic diagrams of the data formatter of the controller of the third embodiment in accordance with the present disclosure. As shown in FIG. 11A, each of the first data formatter 121A and the second data formatter 121B includes a decoder 1211 and a data generator 1212.

The first input signal VS includes only the pattern data to be displayed. Therefore, after the decoder 1211 of the first data formatter 121A decodes the first input signal VS to generate the first video data VD1, the data generator 1212 of the first data formatter 121A directly outputs the first video data VD1.

The second input signal CS includes not only the pattern data to be displayed, but also includes a control instruction CI. The decoder 1211 of the second data formatter 121B decodes the second input signal CS so as to generate an input video data VI and the control instruction CI, and the data generator 1212 of the second data formatter 121B adjusts the input video data VI according to the control instruction CI to generate the second video VD2.

As shown in FIG. 11B, the data generator 1212 of the second data formatter 121B modifies the video input signal VI according to the control instruction CI (e.g. the data generator 1212 can change the font, arrangement, size, or color of the input video data VI) so as to generate the second video data VD2.

Alternatively, the second input signal CS can include only the control instruction CI, and the data generator 1212 of the second data formatter 121B picks out the corresponding video data from the second look-up table L2 according to the control instruction CI in order to generate the video data VD, which is similar to the embodiment shown in FIG. 7.

The embodiment described above is just for illustration; the functions of the elements of the controller 12 and the cooperation thereof can be changed according to actual requirements.

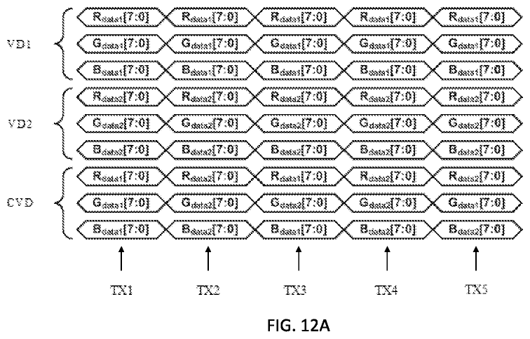

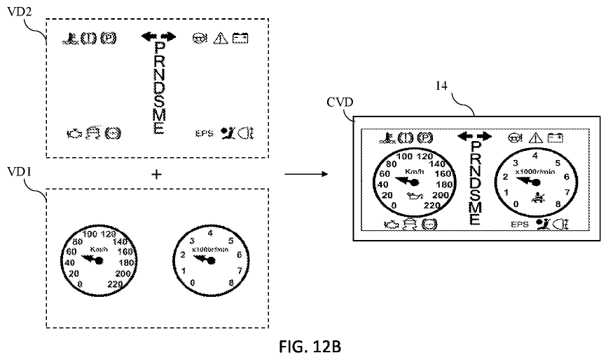

FIG. 12A and FIG. 12B are first˜second schematic diagrams of the video combiner of the third embodiment in accordance with the present disclosure. As described above, the video combiner 17 can combine all inputted video data, which can select the sub-pixel data from all input video data, and then generate the combined video data CVD according to the selected sub-pixel data. In addition, the video combiner 17 can also modify the content of the combined video data CVD, or further interpolate or extrapolate additional pixels into combined video data CVD. In this way, the display system 1 can display the combined video data CVD by different ways.

The video combiner 17 can select the sub-pixel data from the first video data VD1 and the second video data VD2, and can generate the combined video data CVD according to the selected sub-pixel data in order to combine the first video data VD1 with the second video data VD2.

As shown in FIG. 12A, R_{data1}[7:0], G_{data1}[7:0], and B_{data1}[7:0] stand for 8-bit red sub-pixel data, 8-bit green sub-pixel data, and 8-bit blue sub-pixel data of the first video data VD1 at the coordinate [7:0]. R_{data2}[7:0], G_{data2}[7:0], and B_{data2}[7:0] stand for 8-bit red sub-pixel data, 8-bit green sub-pixel data, and 8-bit blue sub-pixel data of the second video data VD2 at the coordinate [7:0]. In the time axis TX1, the combined video data CVD at the coordinate [7:0] displays the pixel data of the first video data VD1. In the time axes TX2 and TX4, the combined video data CVD at the coordinate [7:0] displays the pixel data of the second video data VD2. In the time axes TX3, the combined video data CVD at the coordinate [7:0] alternatively displays the sub-pixel data of the first video data VD1 and the second video data VD2. In this way, the video combiner 17 can display the first video data VD1 and the second video data VD2 in the different time axes by different ways.

As shown in FIG. 12B, by means of the above method, the video combiner 17 can combine the first video data VD1 with the second video data VD2 to generate the combined video data CVD, so the combined video data CVD displayed on the display panel 14 can have the desired patterns and colors.

The embodiment described above is just for illustration; the functions of the elements of the video combiner 17 and the cooperation thereof can be changed according to actual requirements.

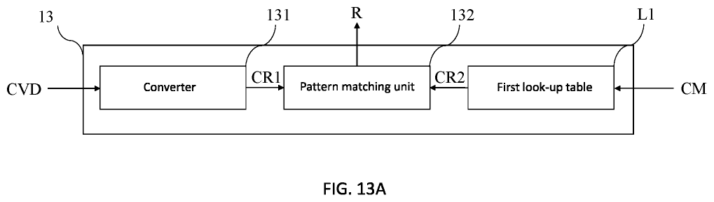

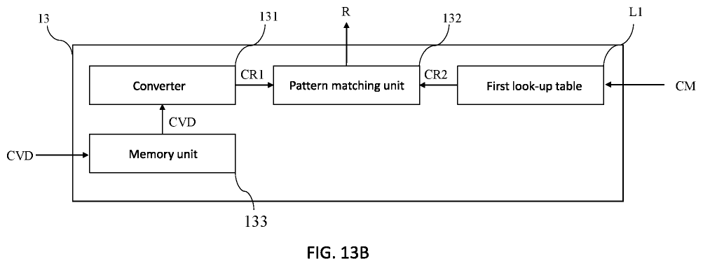

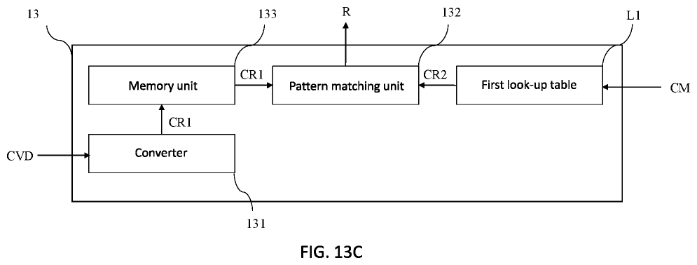

FIG. 13A, FIG. 13B and FIG. 13C are first˜third schematic diagrams of the content checker of the third embodiment in accordance with the present disclosure. As described above, the content checker 13 can compare the combined video data CVD with the first look-up table L1 according to the content checking instruction CM so as to confirm whether the combined video data CVD is correct. As shown in FIG. 13A, the content checker 13 includes a converter 131, a pattern matching unit 132, and a first look-up table L1.

The converter 131 executes a cyclic redundancy check (CRC) to calculate the cyclic redundancy check result CR1 of the combined video data CVD. More specifically, the converter 13 can execute the cyclic redundancy check to calculate the cyclic redundancy check result CR1 of the combined video data CVD on the basis of pixel-by-pixel, line-by-line, region-by-region, and frame-by-frame.

The first look-up table L1 stores a plurality of pre-calculated cyclic redundancy check results in advance. After receiving the content checking instruction CM, the first look-up table L1 selects the pre-calculated cyclic redundancy check result CR2 corresponding to the combined video data CVD according to the content checking instruction CM.

The pattern matching unit 132 compares the cyclic redundancy check result CR1 with the pre-calculated cyclic redundancy check result CR2 in order to determine whether the cyclic redundancy check result CR1 matches the pre-calculated cyclic redundancy check result CR2. If the cyclic redundancy check result CR1 matches the pre-calculated cyclic redundancy check result CR2, the pattern matching unit 132 transmits a confirmation report R to the processor 11. On the contrary, if the cyclic redundancy check result CR1 does not match the pre-calculated cyclic redundancy check result CR2, the pattern matching unit 132 transmits an error report to the processor 11. In this way, the display system 1 can determine whether the inputted video data is correctly displayed on the display panel 14. Besides, if the first look-up table L1 does not have the video data corresponding to the combined video data CVD, the controller 12 displays the combined video data CVD by a default display mode.

FIG. 13B shows another kind of content checker 13. As shown in FIG. 13B, the content checker 13 includes a converter 131, a pattern matching unit 132, a memory unit 133, and a first look-up table L1.

The difference between FIG. 13A and the FIG. 13B is that the content checker 13 shown in FIG. 13B includes a memory unit 133. The memory unit 133 can save the combined video data CVD first, and then input the combined video data CVD into the converter 131 in order to make sure that the combined video data CVD is never lost. The functions of the other elements of the content checker 13 and the cooperation thereof are similar to those shown in FIG. 13A, so will not be described herein.

FIG. 13C shows still another kind of content checker 13. As shown in FIG. 13C, the content checker 13 includes a converter 131, a pattern matching unit 132, a memory unit 133, and a first look-up table L1.

The difference between FIG. 13B and the FIG. 13C is that the converter 131 shown in FIG. 13C can execute a cyclic redundancy check to calculate the cyclic redundancy check result CR1 of the combined video data CVD, and store the a cyclic redundancy check result CR1 in the memory unit 133. Then, the memory unit 133 transmits the cyclic redundancy check result CR1 to the pattern matching unit 132. The functions of the other elements of the content checker 13 and the cooperation thereof are similar to those shown in FIG. 13B, so will not be described herein. The memory unit 133 can store the cyclic redundancy check result CR1, so the calculation times of the converter 131 can be reduced in order to increase the calculation speed of the content checker 13.

The embodiment described above is just for illustration; the functions of the elements of the content checker 13 and the cooperation thereof can be changed according to actual requirements.

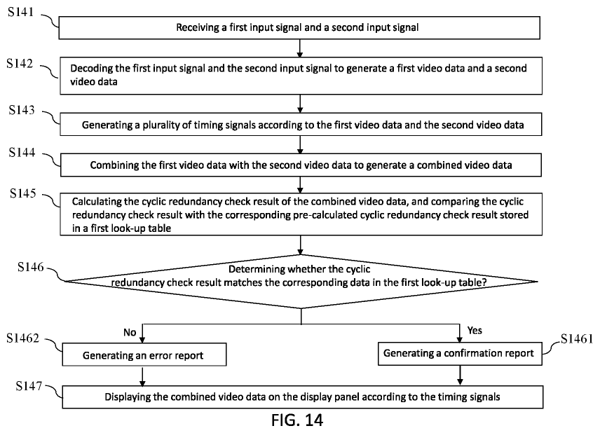

FIG. 14 is a flow chart of a video data displaying method of the third embodiment in accordance with the present disclosure. As shown in FIG. 14, the video data displaying method of the display system 1 includes the following steps:

Step S141: Receiving a first input signal and a second input signal; then, the process proceeds to Step S142.

Step S142: Decoding the first input signal and the second input signal to generate a first video data and a second video data; then, the process proceeds to Step S143.

Step S143: Generating a plurality of timing signals according to the first video data and the second video data; then, the process proceeds to Step S144.

Step S144: Combining the first video data with the second video data to generate a combined video data; then, the process proceeds to Step S145.

Step S145: Calculating the cyclic redundancy check result of the combined video data, and comparing the cyclic redundancy check result with the corresponding pre-calculated cyclic redundancy check result stored in a first look-up table; then, the process proceeds to Step S146.

Step S146: Determining whether the cyclic redundancy check result matches the corresponding data in the first look-up table? If it does, the process proceeds to Step S1461; if it does not, the process proceeds to Step S1462.

Step S1461: Generating a confirmation report; then, the process proceeds to Step S147.

Step S1462: Generating an error report; then, the process proceeds to Step S147.

Step S147: Displaying the combined video data on the display panel according to the timing signals.

It is worthy to point out that when multiple sets of video data are inputted into a conventional display system, these video data displayed on a display panel of the conventional display system may be overlapped with one another. Thus, the conventional display system cannot correctly display multiple sets of video data. On the contrary, according to one embodiment of the present disclosure, the display system includes a video combiner, which can combine multiple sets of video data to generate a combined video data in order to display the combined video data on a display panel. Thus, the display system can avoid that these video data displayed on the display screen of the display panel are overlapped with one another, so can correctly display multiple sets of video data. In addition, the video combiner can further modify the content of the combined video data, so the display system can display the combined video data by different ways, which can better the display performance of the display system.

Besides, when a video data is inputted into the conventional display system, the display panel of the conventional display system may not correctly display the video data due to data error because the internal circuit of the display system malfunctions, or the format of the inputted video data is incorrect. However, the conventional display system cannot determine whether the inputted video data is correctly displayed. On the contrary, according to one embodiment of the present disclosure, the display system includes a content checker having a look-up table storing correct video data in advance. The content checker can compare an inputted video data with the look-up table in order to determine whether the video data is correct. Accordingly, the display system can effectively confirm whether the inputted video data is correctly displayed on a display panel.

Further, according to one embodiment of the present disclosure, the controller of the display system includes a data formatter, which can interpolate or extrapolate additional pixels into an inputted video data. Therefore, the video data can have proper resolution, and can be correctly displayed on a display panel by different ways, which can further better the display performance of the display system.

Moreover, according to one embodiment of the present disclosure, the display system and the video data displaying method can be applied to LCD display systems, so are more comprehensive in use. As described above, the system and method according to the embodiments of the present disclosure definitely have an inventive step.

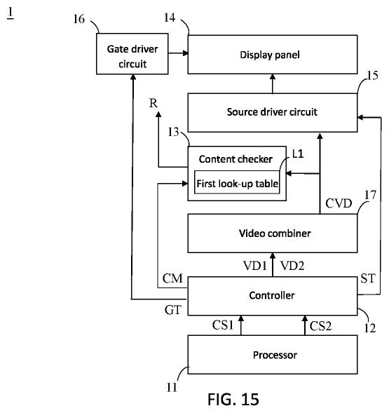

FIG. 15 is a schematic diagram of a display system of a fourth embodiment in accordance with the present disclosure. As shown in FIG. 15, the display system 1 includes a processor 11, a controller 12, a content checker 13, a display panel 14, a source driver circuit 15, a gate driver circuit 16, and a video combiner 17.

The difference between the embodiment and the previous embodiment is that the processor 11 can generate a first input signal CS1 and a second input signal CS2, and each of the first input signal CS1 and the second input signal CS2 includes a control instruction. Thus, the data formatters of the controller 12 generate a first video data VD1 and a second video data VD2 respectively according to the input video data of the first input signal CS1 and the second input signal CS2, and the control instruction, and simultaneously generate a source timing signal ST, a gate timing signal GT, and a content checking instruction CM. The functions of the other elements of the display system 1 and the cooperation thereof are similar to those of the previous embodiment, so will not be described herein.

The embodiment described above is just for illustration; the functions of the elements of the display system 1 and the cooperation thereof can be changed according to actual requirements.

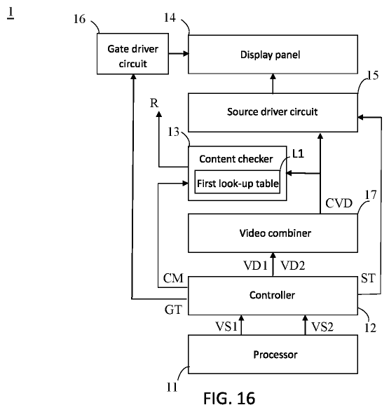

FIG. 16 is a schematic diagram of a display system of a fifth embodiment in accordance with the present disclosure. As shown in FIG. 16, the display system 1 includes a processor 11, a controller 12, a content checker 13, a display panel 14, a source driver circuit 15, a gate driver circuit 16, and a video combiner 17.

The difference between the embodiment and the previous embodiment is that the processor 11 can generate a first input signal VS1 and a second input signal VS2, and the first input signal VS1 and the second input signal VS2 do not includes a control instruction. Thus, the data formatters of the controller 12 decode the first input signal VS1 and a second input signal VS2 to generate a first video data VD1 and a second video data VD2, directly output the first video data VD1 and the second video data VD2, and simultaneously generate a source timing signal ST, a gate timing signal GT, and a content checking instruction CM. Afterward, the video combiner 17 combines the first video data VD1 with the second video data VD2 so as to generate a combined video data CVD. The functions of the other elements of the display system 1 and the cooperation thereof are similar to those of the previous embodiment, so will not be described herein.

The embodiment described above is just for illustration; the functions of the elements of the display system 1 and the cooperation thereof can be changed according to actual requirements.

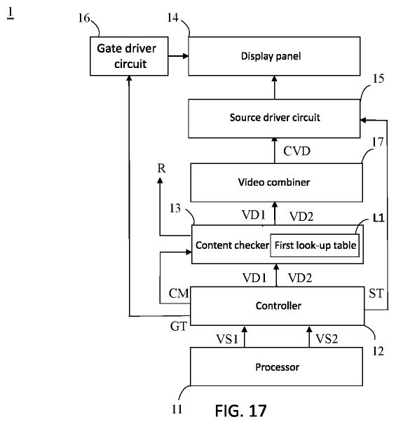

FIG. 17 is a schematic diagram of a display system of a sixth embodiment in accordance with the present disclosure. As shown in FIG. 17, the display system 1 includes a processor 11, a controller 12, a content checker 13, a display panel 14, a source driver circuit 15, a gate driver circuit 16, and a video combiner 17.

The difference between the embodiment and the previous embodiment is that after the data formatters of the controller 12 decodes the first input signal VS1 and the second input signal VS2 to generate the first video data CD1 and the second video data VD2 respectively, the controller 12 directly outputs the first video data VD1 and the second video data VD2 to the content checker 13, and simultaneously generate the source timing signal ST, the gate timing signal GT, and the content checking instruction CM. The content checker 13 compares the first video data VD1 and the second video data VD2 with a first look-up table L1 in order to determine whether the first video data VD1 and the second video data VD2 are correct. If the first video data VD1 and the second video data VD2 match the corresponding video data in the first look-up table L1, the content checker 14 transmits a confirmation report R to the processor 11. On the contrary, if the first video data VD1 and the second video data VD2 do not match the corresponding video data in the first look-up table L1, the content checker 14 transmits an error report to the processor 11. Besides, if the first look-up table L1 does not have the video data corresponding to the first video data VD1 and the second video data VD2, the controller 12 displays the combined video data CVD on the display panel 14 by a default display mode. The functions of the other elements of the display system 1 and the cooperation thereof are similar to those of the previous embodiment, so will not be described herein.

The embodiment described above is just for illustration; the functions of the elements of the display system 1 and the cooperation thereof can be changed according to actual requirements.

In summation of the description above, according to one embodiment of the present disclosure, the display system includes a video combiner, which can combine multiple sets of video data to generate a combined video data in order to display the combined video data on a display panel. Thus, the display system can avoid that these video data displayed on the display screen of the display panel are overlapped with one another, so can correctly display multiple sets of video data.

Also, according to one embodiment of the present disclosure, the display system includes a video combiner, which can combine multiple sets of video data to generate a combined video data, and can further modify the content of the combined video data. Therefore, the display system can display the combined video data by different ways, which can better the display performance of the display system.

Further, according to one embodiment of the present disclosure, the controller of the display system includes a data formatter, which can interpolate or extrapolate additional pixels into an inputted video data. Therefore, the video data can have proper resolution, and can be correctly displayed on a display panel by different ways, which can further better the display performance of the display system.

Moreover, according to one embodiment of the present disclosure, the display system includes a content checker having a look-up table storing correct video data in advance. The content checker can compare an inputted video data with the look-up table in order to determine whether the video data is correct. Accordingly, the display system can effectively confirm whether the inputted video data is correctly displayed on a display panel.

Furthermore, according to one embodiment of the present disclosure, the display system and the video data displaying method can be applied to LCD display systems, so are more comprehensive in use.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A display system, comprising:
a processor;
a controller, configured to receive a first input signal and a second input signal, generate a first control instruction and a second control instruction according to the first input signal and the second input signal respectively, and generate a first video data, a second video data, and a plurality of timing signals respectively according to the first control instruction and the second control instruction;
a video combiner, configured to combine the first video data with the second video data to generate a combined video data; and
a display panel, configured to display the combined video data according to the timing signals.

2. The display system of claim 1, further comprising a gate driver circuit and a source driver circuit coupled to the display panel, wherein the timing signals include a gate timing signal and a source timing signal, and the gate driver circuit and the source driver circuit receive the gate timing signal, the source timing signal, and the first video data respectively in order to control the display panel to display the combined video data.

3. The display system of claim 1, wherein the video combiner selects a sub-pixel data from the first video data or the second video data, and generate the combined video data according to the sub-pixel data.

4. The display system of claim 1, further comprising a content checker, wherein the content checker comprises a first look-up table, and the content checker compares the first video data and the second video data with the first look-up table, and transmits a report to the controller or the processer according to a comparison result.

5. The display system of claim 4, wherein the content checker further comprises a converter and a pattern matching unit; the converter executes a cyclic redundancy check to calculate a cyclic redundancy check result of the first video data and the second video data; the first look-up table selects and outputs a pre-calculated cyclic redundancy check result corresponding to the first video data and the second video data to the pattern matching unit according to a content checking instruction; the pattern matching unit compares the cyclic redundancy check result with the pre-calculated cyclic redundancy check result in order to generate the report.

6. The display system of claim 1, further comprising a content checker, wherein the content checker comprises a first look-up table, and the content checker compares the combined video data with the first look-up table, and transmits a report to the controller or the processer according to a comparison result.

7. The display system of claim 6, wherein the content checker further comprises a converter and a pattern matching unit; the converter executes a cyclic redundancy check to calculate a cyclic redundancy check result of the combined video data; the first look-up table selects and outputs a pre-calculated cyclic redundancy check result corresponding to the combined video data to the pattern matching unit according to a content checking instruction; the pattern matching unit compares the cyclic redundancy check result with the pre-calculated cyclic redundancy check result in order to generate the report.

8. The display system of claim 1, wherein the controller comprises a first data formatter, a second data formatter, and a timing controller; the first data formatter and the second data formatter are coupled to the timing controller, and convert the first input signal and the second input signal into the first video data and the second video data respectively; the timing controller generates the timing signals according to the first video data and the second video data.

9. The display system of claim 8, wherein the first data formatter comprises a first decoder and a first data generator coupled to the first decoder and comprising a second look-up table; the first decoder decodes the first input signal to generate the first control instruction, and the first data generator picks out a corresponding video data from the second look-up table according to the first control instruction in order to generate the first video data.

10. The display system of claim 8, wherein the second data formatter comprises a second decoder and a second data generator coupled to the second decoder and comprising a third look-up table; the second decoder decodes the second input signal to generate the second control instruction, and the second data generator picks out a corresponding video data from the third look-up table according to the second control instruction in order to generate the second video data.

11. A display system, comprising:
a processor;
a controller, configured to receive a first input signal and a second input signal, generate a first input video data and a first control instruction according to the first input signal, generate a second input video data and a second control instruction according to the second input signal, and generate a first video data, a second video data, and a plurality of timing signals respectively according to the first input video data, the first control instruction, the second input video data and the second control instruction;
a video combiner, configured to combine the first video data with the second video data to generate a combined video data; and
a display panel, configured to display the combined video data according to the timing signals.

12. The display system of claim 11, further comprising a gate driver circuit and a source driver circuit coupled to the display panel, wherein the timing signals include a gate timing signal and a source timing signal, and the gate driver circuit and the source driver circuit receive the gate timing signal, the source timing signal, and the first video data respectively in order to control the display panel to display the combined video data.

13. The display system of claim 11, wherein the video combiner selects a sub-pixel data from the first video data or the second video data, and generate the combined video data according to the sub-pixel data.

14. The display system of claim 11, further comprising a content checker, wherein the content checker comprises a first look-up table, and the content checker compares the first video data and the second video data with the first look-up table, and transmits a report to the controller or the processer according to a comparison result.

15. The display system of claim 14, wherein the content checker further comprises a converter and a pattern matching unit; the converter executes a cyclic redundancy check to calculate a cyclic redundancy check result of the first video data and the second video data; the first look-up table selects and outputs a pre-calculated cyclic redundancy check result corresponding to the first video data and the second video data to the pattern matching unit according to a content checking instruction; the pattern matching unit compares the cyclic redundancy check result with the pre-calculated cyclic redundancy check result in order to generate the report.

16. The display system of claim 11, further comprising a content checker, wherein the content checker comprises a first look-up table, and the content checker compares the combined video data with the first look-up table, and transmits a report to the controller or the processer according to a comparison result.

17. The display system of claim 16, wherein the content checker further comprises a converter and a pattern matching unit; the converter executes a cyclic redundancy check to calculate a cyclic redundancy check result of the combined video data; the first look-up table selects and outputs a pre-calculated cyclic redundancy check result corresponding to the combined video data to the pattern matching unit according to a content checking instruction; the pattern matching unit compares the cyclic redundancy check result with the pre-calculated cyclic redundancy check result in order to generate the report.

18. The display system of claim 11, wherein the controller comprises a first data formatter, a second data formatter, and a timing controller; the first data formatter and the second data formatter are coupled to the timing controller, and convert the first input signal and the second input signal into the first video data and the second video data respectively; the timing controller generates the timing signals according to the first video data and the second video data.

19. The display system of claim 18, wherein the first data formatter comprises a first decoder and a first data generator coupled to the first decoder; the first decoder decodes the first input signal to generate the first input video data and the first control instruction, and the first data generator adjusts the first input video data according to the first control instruction so as to generate the first video data.

20. The display system of claim 18, wherein the second data formatter comprises a second decoder and a second data generator coupled to the second decoder; the second decoder decodes the second input signal to generate the second input video data and the second control instruction, and the second data generator adjusts the second input video data according to the second control instruction so as to generate the second video data.
